(19) United States
(12) Patent Application Publication
(10) Pub. No.: US 2009/0116843 A1
(43) Pub. Date: May 7, 2009

(54) Device for Transmitting and Receiving Data and Corresponding Operating Method

(75) Inventor: Harald Rohde, Munchen (DE)

Correspondence Address: STAAS & HALSEY LLP, SUITE 700, 1201 NEW YORK AVENUE, N.W., WASHINGTON, DC, 20005, US

(73) Assignee: SIEMENS HOME AND OFFICE COMMUNICATION DEVICES GMBH, Muenchen (DE)

(21) Appl. No.: 11/988,996

(22) PCT Filed: May 12, 2006
(86) PCT No.: PCT/EP2006/004497

§ 371 Date: Jan. 18, 2008

(51) Int. Cl. H04B 10/00

(52) U.S. Cl. 398/115

(57) ABSTRACT

A passive device includes an optical-to-electrical converter unit, an electrical-to-optical converter unit, an antenna and a polymer modulator.

### BACKGROUND

Described below is a device for transmitting and receiving data, having an optical-to-electrical converter unit, an electrical-to-optical converter unit, and an antenna unit, which can both transmit and receive. This device, for instance, is what is known as an antenna front-end for optical radio applications, which are described in greater detail below.

The optical-to-electrical converter unit converts optical signals into electrical signals. The frequency of an optical carrier beam lies, for example, in the frequency range 187 Terahertz to 1 Petahertz, in other words it has a wavelength in the range 1.6 micrometers to 300 nano-meters, i.e. it also includes visible light. A radio signal, for example, is modulated onto the optical beam. The radio signal has, for example, one or more carrier frequencies in the range 3 Megahertz to 100 Gigahertz or higher, in particular in the range 1 Gigahertz to 60 Gigahertz. For instance, the radio signal is a mobile communications signal or a WLAN signal (Wireless Local Area Network).

The electrical-to-optical converter unit, on the other hand, converts an electrical signal in the frequency range into an optical signal of the optical frequency range. The design of the antenna unit is matched to the carrier frequency of the radio frequency.

The device would only be especially expensive to produce when both converter units, for example, are implemented in a single component, in particular in a semiconductor component made of a monocrystalline inorganic material.

### SUMMARY

Described below is a device of simple design, and a simple method for operating the device. In particular, the device shall work independently of a supply voltage or using a small supply voltage, in particular less than 5 Volts or less than 1 Volt.

The device is based on the idea that the device can be manufactured easily when both converter units are physically and functionally separate from each other. In particular, it is then possible to use for each converter unit, independently of the other converter unit, those converter units that have a high level of efficiency for the respective conversion direction. In addition, the device is based on the idea that passive operation, in particular, or operation using a small supply voltage, enables a simple design for the device, because no additional power supply needs to be provided, i.e. in particular no power supply units, no batteries or rechargeable batteries or similar power supplies.

In a development, the device does not contain any external supply voltage. Consequently, the power for operation is obtained solely from the incident light or from the incident electromagnetic radiation. Hence there is no need for the expense of circuitry for generating a supply voltage. There are also no servicing costs for maintaining power supplies.

Hence in a development of the device, a polymer modulator is used for the electrical-to-optical converter unit. Polymer modulators allow only the conversion of electrical signals into optical signals. Polymers are macromolecules of molecular weights greater than 10⁴ gmol⁻¹, for example. In particular, organic polymers or other polymers are used. For example, a polymer modulator is used that contains polymers oriented with the electric field, otherwise known as polar polymers. This means that a material is used in which a material having a heavily non-linear electro-optical effect is injected or diffused into a polymer having a low dielectric constant. The resultant material undergoes a field orientation process to produce a material that has a large dielectric constant, or electro-optical constant. There are also polymer modulators that have other operating principles, however, e.g. intrinsically polar Self-Assembled chromophoric Super-lattices (SAS).

Polymer modulators can be manufactured far more simply and hence more cheaply than monocrystalline semiconductor components. In addition, polymer modulators can be operated passively. Hence an antenna front-end, or in other words a device for transmitting and receiving data, is obtained that can be manufactured simply and at low-cost. Thus it becomes economically viable to implement new applications, for instance setting up a multiplicity of “pico-cells”, i.e. radio cells having a receive/transmit range of less than 35 meters.

In a development of the device, the electrical-to-optical converter unit is a modulator that works using interference effects, in particular a Mach-Zehnder modulator. The interference effects are caused by differences in propagation times in two optical transmission paths. Laser light is particularly suitable for producing pronounced interference effects.

In a further development, the electrical-to-optical converter unit (14, 14a) is an electro-absorption modulator. The electro-absorption modulator is based on the Franz-Keldysh effect, or on its reverse effect. By using a diode as optical-to-electrical converter unit, however, in addition to an electrical-to-optical electro-absorption modulator it is possible to design a passive antenna front-end that has numerous advantages, for example as regards the efficiency of the optical-to-electrical conversion or as regards avoiding any mutual interference between the two conversion types.

If applicable, the electrical-to-optical converter unit also contains other elements such as filters. The optical-to-electrical converter unit may also contain other units e.g. filters.

In another development of the device, the optical-to-electrical converter unit is an optical diode, in particular a photodiode. Semiconductor diodes that use semiconductors having direct bandgaps between the conduction band and valence band are particularly suitable, i.e. silicon diodes for instance. Both diodes with p/n junctions and diodes with pin-junctions (p-type, intrinsic, n-type) are used. Hence it is not necessary to use in this position relatively expensive components based on composite semiconductors or semiconductors having indirect bandgaps, i.e. having a bandgap across which not only the energy of an electron or “hole” changes but also its momentum.

In another development of the device, the antenna is connected to a circulator unit or a directional coupler unit. By using a circulator unit or a directional coupler unit, a single antenna per device can be used, so that it may be possible to save costs, depending on the antenna used. Unwanted feedback effects are easy to avoid by using the circulator unit or directional coupler unit.

In a development, the circulator unit or the directional coupler unit also operates passively, i.e. it has no external supply voltage terminals. Thus the entire device also remains electrically passive.

In contrast in an alternative development, two antennas are used, so that no circulator unit or directional coupler unit is required. This version is used particularly when the price of an antenna is less than the price of the circulator unit or the directional coupler unit.

In a further development, the device contains a connecting device that is suitable for connecting an optical fiber over which data can be transmitted in both directions i.e. bidirectionally. Alternatively, the device contains two connecting devices for connecting two optical fibers. In a further development, the connecting devices are part of a screw connection, i.e. they have an internal thread or an external thread. The optical fibers can thereby be connected to the device simply and securely.

In a method for operating the device, data for terminal equipment of networks that differ from each other and operate different network standards is transmitted via the device based on a multiplexing technique. Suitable multiplexing techniques are, in particular, time division, frequency division, code division multiplexing etc.

In a development, data is transmitted for terminal equipment of at least two, at least three or based on all of the following network standards:

DECT (Digital Enhanced Cordless Telecommunication),

GSM (Global System for Mobile Communication),

UMTS (Universal Mobile Telecommunication System),

WLAN (Wireless Local Area Network), and

WiFi

Other data transmission methods, however, are also implemented in conjunction with the device or its developments.

Passive filters are used in the device, for example, to separate the signals for the different networks. In addition, suitable antennas for the different standards are connected in parallel.

In summary, an antenna front-end for passive optical radio applications is defined by way of example. The generic term “optical radio” is used to denote technologies in which some or all of the signals to be transmitted are transmitted either in baseband or in the radio-frequency band via an optical fiber e.g. a glass fiber or a polymer fiber. For example, it concerns the situation in which the signal modulated onto the light in a glass fiber already carries the full radio-frequency information, and can be passed to an antenna directly after optical-to-electronic conversion. The radiated RF energy (Radio Frequency) can here come directly from the light, and the received RF signal can re-modulate the light directly, for example at a different frequency, so that passive antenna front-ends are possible that are only connected via a glass fiber or plastic fiber. One example application is supplying radio pico-cells in a building using a wireless data communications network.

Problems arising in implementing such antenna front-ends relate to future technologies, so that it is not easily possible to resort to previously known solutions. The antenna front-end is integrated on a polymer wafer or polymer chip, for example. The light in the “downstream optical fiber” is divided into two parts by a beam splitter: one part is converted into an electrical signal by a photodiode attached to the polymer chip, and the other part passes through a polymer modulator, to which are input the received radio signals, for example transmitted from mobile equipment. An electrical circulator, for example, isolates the RF upstream and the RF downstream. Inexpensive polymer components can hence be used in order to reduce the price of the antenna front-end to a few Euros.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of a passive antenna front-end having a circulator,

FIG. 2 is a block diagram of a passive antenna front-end having a separate transmit antenna and a separate receive antenna,

FIG. 3 is a block diagram of a passive antenna front-end having a terminal to a single glass fiber, and

FIG. 4 is a block diagram of pico-cells arranged in a building and implemented using passive antenna front-ends.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

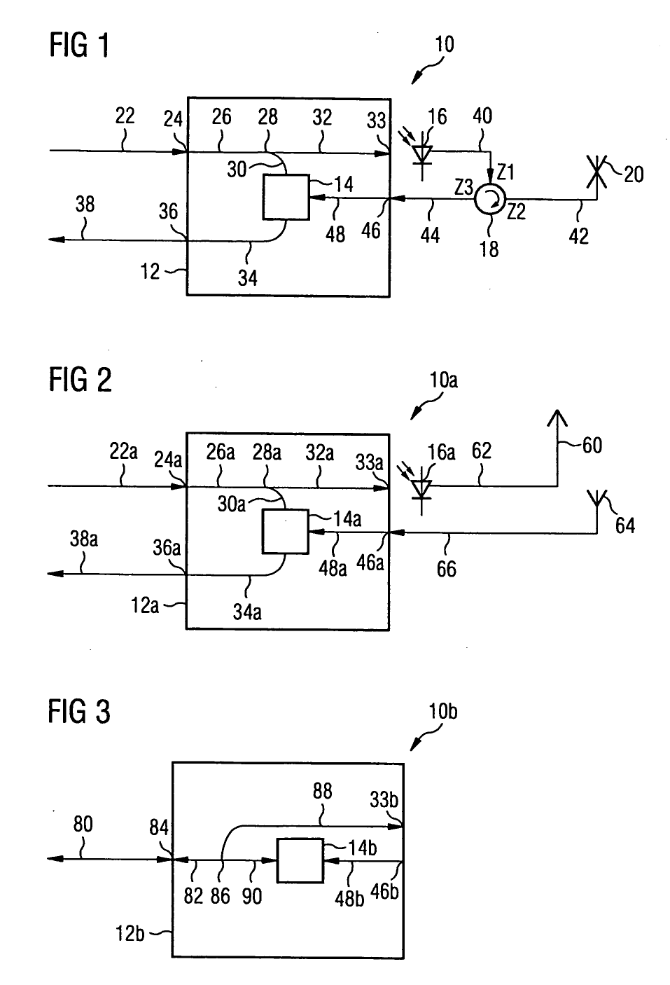

FIG. 1 shows a passive antenna front-end 10, which contains a polymer chip 12 including a polymer converter 14. In addition, the antenna front-end 10 contains a photodiode 16, a circulator 18 and a transmit-and-receive-antenna 20, which, for example, is also integrated on the polymer chip 12 in a hybrid design.

An incoming optical fiber 22 is connected via a connecting device 24, e.g. a screw connection, to an optical waveguide 26 integrated on the polymer chip 12. The optical waveguide 26 leads from the connecting device 24 to a branch 28, e.g. to a beam splitter. A light-conducting section 30 leads from the branch 28 to an input of the polymer converter 14. A light-conducting section 32 leads from the branch 28 to a light outlet 33. The sections 30 and 32 are also integrated on the polymer chip 12. The light outlet 33 faces an active surface of the photodiode 16, so that the light emitted from the outlet 33 hits the photodiode 16 and generates there a voltage or a current.

An optical waveguide 34 is likewise integrated on the polymer chip 12, and leads from an output of the polymer converter 14 to a connecting device 36, e.g. to a screw connection. Connected to the connecting device 36 is an outgoing optical fiber 38, which transfers the light emitted from the polymer modulator 14.

A link 40 leads from a terminal of the photodiode 16 to an input Z1 of the circulator 18. Depending on the frequency of the radio signal received by the photodiode 16, the link 40 is an electrically conducting link, a microwave transmission line, a stripline etc. A link 42 lies between a terminal Z2

of the circulator 18 and a transmit-and-receive-antenna 20. The terminal Z2 of the circulator 18 is operated as an input and as an output.

A link 44 lies between an output Z3 of the circulator 18 and a terminal 46. Another link 48 lies between the terminal 46 and a control input of the polymer converter 14. The links 42, 44 and 48 have the same construction as the link 40. The circulator 18 contains a pre-magnetized ferrite, for example, which causes high-frequency signals to pass from the input Z1 to the terminal Z2, and from there to the antenna 20. Conversely, signals that reach the terminal Z2 from the antenna 20, are routed through the circulator 18 to the output Z3. Hence no signals reach the output Z3 from the input Z1. Instead of the circulator 18, a directional coupler can also be used, in which no signals are routed from Z3 to Z1, as would be the case for a circulator.

FIG. 2 shows an antenna front-end 10a, which has the same design as the antenna front-end 10 except for the differences described below. Parts having the same design are given the same reference number, although parts in the antenna front-end 10a are suffixed with the lowercase letter “a”, for instance cf. polymer converter 14a compared to polymer converter 14. Unlike the antenna front-end 10, the antenna front-end 10a has, instead of the transmit-and-receive-antenna 20, a separate transmit antenna 60, which is connected to a terminal of the photodiode 16a via a link 62. In addition, the antenna front-end 10a has a receive antenna 64, which is connected via a link 66 to a terminal 46a, which has the same function as the terminal 46. Thus there is no circulator present for the antenna front-end 10a.

FIG. 3 shows a passive antenna front-end 10b, which has the same design as the antenna front-end 10 or alternatively as the antenna front-end 10a, except for the differences described below. Parts having the same design and hence the same function are given the same reference number, although the parts in the antenna front-end 10b are suffixed with the lowercase letter “b”, for instance cf. polymer converter 14b compared to polymer converter 14 or 14a. The antenna front-end 10b differs from the antenna front-end 10 or 10a in that only one optical fiber 80 is connected to it, via which light is transmitted bidirectionally i.e. in both transmission directions. The optical fiber 80 is connected to a connecting device 84, e.g. to a screw connection. Integrated in a polymer chip 12b, which corresponds to the polymer chip 12 or 12a, an optical waveguide 82 leads from the connecting device 84 to a branch 86. A section 88 leads from the branch 86 to a light outlet 33b, which corresponds to the light outlet 33 or 33a, i.e. it leads to a photodiode that is not shown in FIG. 3.

A section 90 lies between the branch 86 and an optical terminal of the polymer modulator 14b. Unlike the polymer modulator 14 or 14a, the polymer modulator 14b has only one optical terminal. This can be achieved by applying a reflective coating to one side face of the polymer modulator 14b, for example. A link 48b leads from a terminal 46b, which corresponds to the terminal 46 or 46a, to a control terminal of the polymer modulator 14b. The link 48b is electrically conducting, a microwave transmission line or a stripline etc., for example.

The antenna front-end 10b saves one optical fiber compared with the antenna front-ends 10 and 10a. The design of the polymer converter 14b is slightly more complicated however.

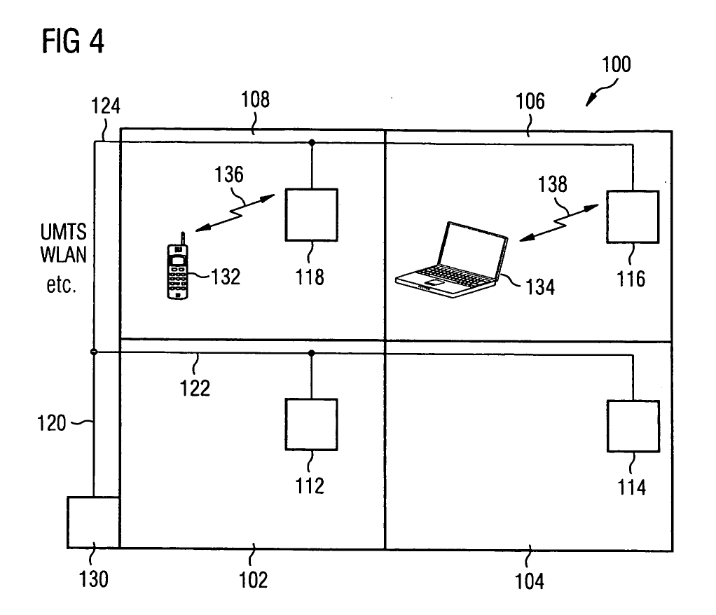

All three antenna front-ends 10, 10a and 10b work without a supply voltage, i.e. passively. An example application for the antenna front-ends 10, 10a and 10b is described in greater detail below with reference to FIG. 4. There are also other possible applications, however, for example MIMO antenna arrays (Multiple Input, Multiple Output).

The three antenna front-ends 10, 10a and 10b can each be fully integrated, for example using hybrid technology. In alternative exemplary embodiments, the antenna(s) is/are not integrated but made as a separate component. In other exemplary embodiments, the polymer chips 12, 12a, 12b are manufactured separately from the other units of the antenna front-end 10, 10a or 10b respectively, and additionally encapsulated if necessary.

In other exemplary embodiments, the antenna front-end 10, 10a or 10b contains an electro-absorption modulator as the electrical-to-optical converter unit 14, 14a or 14b respectively, which, although in principle also being suitable as an optical-to-electrical converter, has a lower conversion efficiency compared with a diode 16, 16a. In these exemplary embodiments, the antenna front-end 10, 10a or 10b is a passive antenna front-end 10, 10a or 10b in particular.

FIG. 4 shows a building 100 in which are arranged pico-cells, in other words rooms 102, 104, 106 and 108, in each of which is disposed a passive antenna front-end 112, 114, 116 and 118 respectively having the same design as the antenna front-end 10, 10a or 10b.

The antenna front-ends of the rooms on one floor are connected via optical tie lines. Thus a tie line 122 connects the antenna front-ends 112 and 114 of the first floor. A tie line 124 connects the antenna front-ends 116 and 118 of the second floor. The tie lines 122 and 124 are connected via a main line 120. The main line 120 and the tie lines 122 and 124 are fiber-optic lines, e.g. glass fibers or plastic fibers. The main line 120 leads to a base unit 130, which performs the function of a WLAN station or the function of a mobile communications base-station, for example.

In another exemplary embodiment, the base unit 130 performs both the function of a WLAN base unit and the function of a UMTS base-station. In this case, the data of the different standards are transmitted over the optical lines 120 to 124 in a multiplexing technique. Thus, a cellular phone 132 in room 108 can send and receive data via the antenna front-end 118; see data transmission link 136. In room 106, on the other hand, there is a portable computer 134, which receives via a data transmission link 138 data that is transmitted in a WLAN data communications network. Similarly, mobile terminals or even stationary terminals in the rooms 102 and 104 can be used to receive and transmit data of different data communications networks using the antenna front-ends 112 or 114 respectively.

Since the antenna front-ends 112 to 118 are passive, a multiplicity of “pico-cells”, i.e. transmit/receive areas of maximum range 35 m can be set up at low cost. The use of pico-cells provides a large number of advantages compared with central antenna stations, for example with regard to exposure to radiation, frequency usage etc.

In other exemplary embodiments, the antenna front-ends 10, 10a, 10b are active, i.e. there is an additional operating voltage supply-unit, e.g., a battery, rechargeable battery or power supply unit.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. A device for transmitting and receiving data, comprising:
an optical-to-electrical converter unit having an output;
an electrical-to-optical converter unit, separate from said optical-to-electrical converter unit and having an input; and
at least one antenna, which when only one antenna, is connected both to the output of said optical-to-electrical converter unit and to the input of said electrical-to-optical converter unit and, when more than one antenna, includes a transmit antenna connected to the output of said optical-to-electrical converter unit and a receive antenna connected to the input of said electrical-to-optical converter unit.

15. The device as claimed in claim 14, wherein the device operates passively and has no built-in voltage supply or supply voltage terminals.

16. The device as claimed in claim 15, wherein said electrical-to-optical converter unit is a polymer modulator or contains a polymer modulator.

17. The device as claimed in claim 15, wherein said electrical-to-optical converter unit includes a Mach-Zehnder modulator that works using interference effects.

18. The device as claimed in claim 15, wherein said electrical-to-optical converter unit is an electro-absorption modulator or contains an electro-absorption modulator.

19. The device as claimed in claim 15, wherein said optical-to-electrical converter unit includes an optical diode.

20. The device as claimed in claim 15, further comprising one of a circulator unit and a directional coupler unit, connected to said at least one antenna and having an input connected to the output of said optical-to-electrical converter unit and an output connected to the input of said electrical-to-optical converter unit.

21. The device as claimed in claim 20, wherein said one of a circulator unit and a directional coupler unit operates passively.

22. The device as claimed in claim 20, wherein the device may be connected to an optical fiber,
wherein said electrical-to-optical converter unit has a terminal that is the input and an output thereof, and
further comprising:
a connecting device suitable for connecting to the optical fiber, and
an optical coupling device connected to said connecting device and the terminal of said electrical-to-optical converter.

23. The device as claimed in claim 20, wherein the device may be connected to optical fibers, and
further comprising:
an optical input coupling device connected to the input of said electrical-to-optical converter unit;
an input connecting device, suitable for connecting to a first optical fiber, connected via said optical input coupling device to the input of said electrical-to-optical converter unit;
an optical output coupling device connected to the output of said electrical-to-optical converter unit; and
an output connecting device, suitable for connecting to a second optical fiber, connected via said optical output coupling device to the output of said electrical-to-optical converter unit.

24. The device as claimed in claim 23, wherein at least one of said input and output connecting devices contains a part of a screw connection.

25. A method for operating a device having an optical-to-electrical converter unit with an output, an electrical-to-optical converter unit, separate from the optical-to-electrical converter unit and with an input, and either one antenna connected both to the output of the optical-to-electrical converter unit and to the input of the electrical-to-optical converter unit, or a transmit antenna connected to the output of the optical-to-electrical converter unit and a receive antenna connected to the input of the electrical-to-optical converter unit, comprising:
transmitting data for terminal equipment of data communications networks that differ from each other via the device based on a multiplexing technique.

26. The method as claimed in claim 25, wherein the data transmitted is for terminal equipment of at least two, of the following network standards: DECT, GSM, UMTS, WLAN and WiFi.
